(19) United States
(12) Patent Application Publication
(10) Pub. No.: US 2010/0003357 A1
(43) Pub. Date: Jan. 7, 2010

(54) GOLF BALL MOLD

(76) Inventors: Ajay Vora, Foxboro, MA (US); Robert A. Wilson, Sagamore, MA (US); Scott Cooper, Warwick, RI (US); Paul J. Valente, New Bedford, MA (US)

Correspondence Address: ACUSHNET COMPANY, 333 BRIDGE STREET, P. O. BOX 965, FAIRHAVEN, MA, 02719, US

(21) Appl. No.: 12/168,285

(22) Filed: Jul. 7, 2008

(51) Int. Cl. B29C 33/20; B29C 45/27

(52) U.S. Cl. 425/116; 425/441

(57) ABSTRACT

An improved mold for making a golf ball comprises a pair of mold cups which are assembled together along mating surfaces that form a parting line. The mold cups are completely without sprues (vents). A lower mold cup has an undercut section of p to 360° in the rim area of the mating surface that allows for a very restricted but controlled flow at the parting line. The undercut section is of a depth of about 0.002 inch or less. This provides for a significant increase in the shear strength that results in a golf ball having less delamination, smaller voids, and a significant increase in impact cover durability.

### FIELD OF INVENTION

The invention relates in general to a mold for making an inner cover layer or a cover for a golf ball, and more particularly, to an improved golf ball mold that utilizes an undercut section of up to 3600 around the rim perimeter in lieu of traditional sprues.

### BACKGROUND OF THE INVENTION

The usual golf ball manufacturing techniques include several different steps, depending on the type of ball, such as one, two, three or even more than three piece balls. According to the traditional method, a solid or composite elastomeric core is made, and an outer dimpled cover is formed around the core.

The two standard methods for molding a cover over a core or a core and inner layers is by compression molding or injection molding. The compression molding operation is accomplished by using a pair of hemispherical molds each of which has an array of protrusions machined or otherwise provided in its cavity, and those protrusions form the dimple pattern on the periphery of the golf ball during the cover molding operation. A pair of hemispherical cover blanks, are placed in a diametrically opposed position on the core of the ball, and the core with the cover blanks thereon are placed in the hemispherical molds, and then subjected to a compression molding operation. The combination of heat and pressure applied during the molding operation results in the cover blanks being fused to the golf ball body and to each other to form a unitary one-piece cover structure which encapsulates the golf ball body. In addition, the cover blanks are simultaneously molded into conformity with the interior configuration of the hemispherical molds which results in the formation of the dimple pattern on the periphery of the golf ball cover. When dimple projections are machined in the mold cavity they are typically positioned below the theoretical parting line of the resulting mold cavity. The parting line is typically finished machined after the dimple forming process. For ease of manufacturing the parting line on the cavity is machined flat and perpendicular to the dimpled surface as to provide a positive shut off preventing flowing cover material from leaking out of the mold. This dimple positioning and flat parting line results in a great circle path on the ball that is essentially void of dimples. This is commonly referred to as the equator, parting line, or seam of the ball. Over the years dimple patterns have been developed to compensate for cosmetics and/or flight performance issues due to the presence of the seam.

As in all molding operations, when the golf ball is removed from the hemispherical molds subsequent to the molding operation, it will have molding flash, and possibly other projecting surface imperfections thereon which are the result of sprues on the surface of the mold. Typically the molding flash is located at the fused circular junction of the cover blanks and the parting line of the hemispherical molds. The molding flash will therefore be on the “equator” of the golf ball.

The molding flash and possible other projecting surface imperfections, need to be removed and this is normally accomplished by one or a combination of the following: cutting blades, sanding belts, grinding stones, or cryogenics and the like. These types of processes tend to enhance the obviousness of the seam. Alternative finishing processes have been developed to minimize this effect. These processes include tumbling with media, stiff brushes, cryogenic de-flashing and the like. Regardless of the finishing process, the result with a flat parting line is an area substantially void of dimple coverage.

When flashing is removed by grinding, it is desirable that the molding operation be accomplished in such a manner that the molding flash is located solely on the surface of the golf ball and does not extend into any of the dimples. In other words, a grinding operation may have difficulty reaching into the dimples of the golf ball to remove the molding flash without ruining the golf ball cover. Therefore, prior art hemispherical molds are primarily fabricated so that the dimple-forming protrusions formed therein are set back from the circular rims, or mouths of their cavities. The result is that the equator of a molded golf ball is devoid of dimples and the molding flash is located solely on the smooth surface provided at the equator of the golf ball.

As it is well known, sprues (vents) are positioned around the rim of golf ball molds keep the molded golf balls/casings attached with the matrix during the de-molding process as well as to establish tabs that aid in orienting the golf ball for the buffing process. However, sprues which are of varying shape and size, will under high pressure closing of the molds, cause significant increase in shear resulting in stress and weakness at the sprue locations. The excess flow of material also can cause large voids in the cavity cups therein creating a problem with quality control.

Therefore, a need exists for elimination of these sprues and to more closely control the flow of cover and inner cover material and therein improve impact cover durability.

### SUMMARY

The present invention provides a mold for forming a cover or an inner cover layer of a golf ball. A golf ball mold comprises hemispherical mold cups, an upper mold cup and a lower mold cup, both cups having interior cavity details, and when assembled create a generally spherical cavity. When forming a cover the mold cups provide a dimple pattern on the golf ball. The present invention is restricted to the lower mold cup in which provides the undercut of 360° or less. A typical mold consists of upper and lower mold cups which have mating surfaces that form a parting line from which flash appears along the parting line. It is on the rim of the rim of the lower mating surface that the undercut is disposed, which allows for a controlled material flow during a high pressure close.

The undercut section works equally well on parting lines that are flat and straight around the ball and on parting lines that are corrugated or wavy.

The mold of the present invention provides for an undercut having a depth of 0.005 inch or less, preferably about 0.001 inch.

### BRIEF DESCRIPTION OF THE DRAWINGS

FIG. 1 is a cross-sectional elevation view of the lower mold half.

FIG. 2 is a cross-sectional view of DETAIL A of FIG. 1.

### DETAILED DESCRIPTION OF THE INVENTION

The present invention comprises a golf ball cavity design for making an inner cover layer or cover for a golf ball. The invention teaches the incorporation of an undercut in the rim of a lower mold half, the undercut having a dept between about 0.001 inch and 0.002 inch, and the rim being without traditional sprues (vents) that are presently found in golf ball molds. The design of the present invention will be equally effective whether the parting line of the mold is that of a flat-rimmed or staggered wave parting line. The present design improves a molded casing core by increasing the durability of the molded cover and reducing the amount of voids that are inherent in mold designs that feature sprues.

In previous designed compression molds the casing material normally flows during the initial high pressure stage, and this flow is in a controlled fashion by use of sprues, as best seen in U.S. Pat. No. 6,644,948 which is incorporated herein, in its entirety, by express reference thereto. The traditional sprues which control the flow are of various shapes and are may range between 0.006 inches to 0.05 inches in cross section. When under a high pressure close a significant increase in shear can result therein causing very stressed/weakened areas at the sprue locations. During the high pressure close, significant amounts of flow have been a problem with molds having sprues. The present invention, by eliminating these sprues and providing an undercut of about 0.001 inch to about 0.002 inch all the way around the rim of the mold, allows the flow to be frozen almost instantly and therein preventing a change in shear at the sprue locations. This prevents a loss of cavity pressure, which happens when flow continues through sprues. The slight relief achieved though the undercut keeps the molded parts integrally connected with the matrix. The net result is a lack of delamination or voids and a significant increase in impact cover durability.

Durability tests were conducted using the Dual Pendulum hitting test and were conducted on a large sample of golf balls which were made with a Fusabond blend casing and traditional Titleist PRO V1® cores and manufactured in either a sprue cavity mold or a sprueless cavity mold with a 0.002 inch undercut.

Those balls that were made using sprue cavities were subjected to velocities of about 138 to 144 and all failed between 132 to 209 cycles. Of the samples of balls made using the sprueless cavities, 92% passed when subjected to velocities of about 140 to 142 and 400 cycles. This is a clear improvement in durability of the golf ball covers.

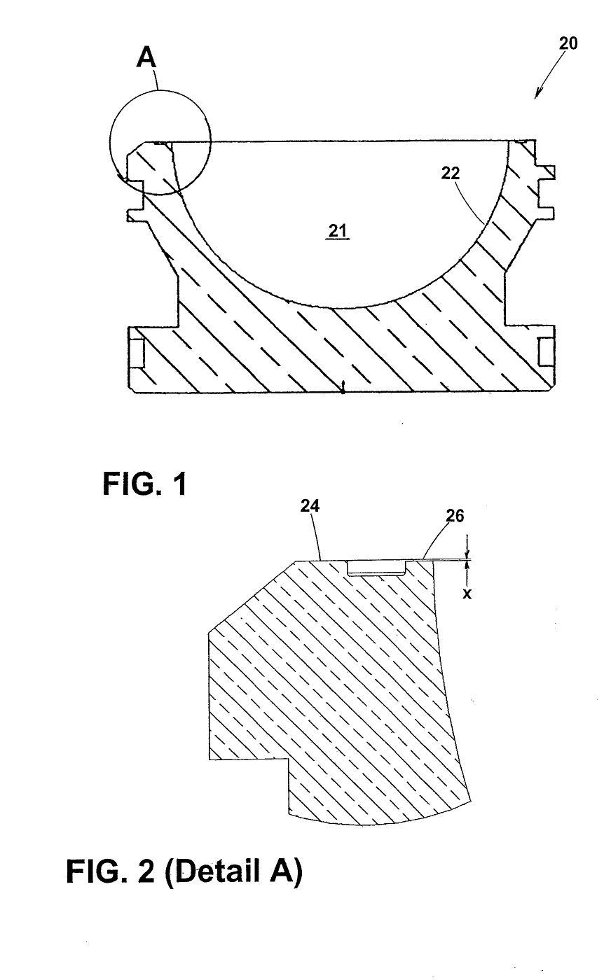

Referring to FIGS. 1 to 2, wherein an improved lower mold of the present invention is shown, with the lower mold being indicated by the reference numeral 20, the lower mold 20 having a semi-spherical cavity 21 for forming a cover for a golf ball wherein the semi-spherical cavity 21 comprises an interior cavity with details of a reverse dimple pattern for forming a cover for a golf ball. The lower mold 20 has a mating surface 24 that mates with a mirror surface of an upper mold cup (not shown). The mating surfaces may be flat, corrugated, or wavy which is often defined by a plurality of peaks and valleys created by multiple radii as described in U.S. Pat. No. 7,387,504, which is incorporated herein, in its entirety, by express reference thereto.

An undercut section 26 as shown in FIG. 2 has a depth x of about 0.001 to 0.002 inch and can provided a 360 degree undercut or less in the top mating surface 24 of the lower mold.

The lower mold 20 is produced in the same manner as standard mold cups up until the machining of the parting line wherein the annual undercut is made by removal of mold material on the mating surface and near to the rim of the mold. When the lower mold cup 20 and upper mold cup are assembled the parting lines mate. However, the molds may have a parting line that is corrugated or wavy with no effect upon the present invention. The main difference in the wavy parting line mold is that the parting line is machined to follow the profile of the equator dimples. Typically, the parting line, as it is machined, is offset from the equator dimples by at least 0.001 inch, as to not interfere with the dimple perimeter. This produces a wavy or corrugated formed parting line consisting of multiple radii forming peaks and valleys as best seen in the '504 patent. Typically, the peaks (the highest point of the parting line) are located above the theoretical center of the cavity half and the valleys (the lowest point) are located below the theoretical center of the cavity half. This offset distance of the peaks and valleys can be as much as about half the dimple diameter or as little as 0.001 inch. Designs which incorporate as little as 0.001 inch offset, provide the benefit of interdigitating dimples, yet only producing a small amount of undercut in the cavity. This alternating geometry is consistent over the entire parting line surface.

The cavity design of the present invention can be applied for any golf ball molding process including injection molding, compression molding and casting. It will work with the standard flat parting line as well as corrugated parting lines used to manufacture “seamless” golf balls which include corrugations that are all on one side of the ball equator, types that have corrugations on both sides of the ball equator, and those that are offset from the equator. The design of the present invention benefits golf manufacturing where perfect registration is desired between mold cups. This minimizes the shift on the molded ball allowing for more accurate buffing. This is especially beneficial for golf balls having a flat parting line, because the dimples therein can be placed very close to the cavity parting line. Due to the reduction in shift upon the ball, the need to remove excessive material to clean the vestige for the parting line is reduced. The result is a ball having a seam with a more pleasing appearance.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all modifications and embodiments, which would come within the spirit and scope of the present invention.

We claim as our invention:

1. A mold for forming a golf ball layer, the mold comprising:
hemispherical upper and lower mold cups being removably mated along a parting line, each mold cup having a interior cavity detail, each mold cup having a mating surface forming the parting line;
a spherical cavity formed therein; and
an undercut in the mating surface of the lower mold cup,
wherein when the mold cups are assembled during a high pressure close the undercut allows for a controlled material flow along the parting line.

2. The mold according to claim 1, wherein the undercut comprises 360 degrees or less of the mating surface.

3. The mold according to claim 1, wherein the layer is an inner cover layer.

4. The mold according to claim 1, wherein the layer is a cover layer

5. The mold according to claim 1, wherein the depth of the undercut is 0.002 inch or less.

6. The mold according to claim 5, wherein the depth of the undercut is 0.001 inch or less.

7. The mold according to claim 1, wherein the mating surfaces of the molds creates a single straight line around an equator of the ball.

8. The mold according to claim 1, wherein the mating surfaces of the molds creates a parting line that is a single corrugated line around the ball.

9. The mold according to claim 1, wherein the mating surfaces of the molds is a result of a superposition of a base waveform with a secondary waveform, whereby wavelength of the secondary waveforms are substantially shorter than that of the base waveform

10. The mold according to claim 9, wherein the secondary waveform is continuous around equator of he molded golf ball.

11. The mold according to claim 9, wherein the secondary waveform is broken into individual segments that are applied in a periodic fashion to the base waveform

12. A sprueless mold for forming a layer for a golf ball, the mold comprising:
hemispherical upper and lower mold cups being removably mated along a substantially flat parting line, each mold cup having an interior cavity detail, each mold cup having a mating surface forming the parting line; and
a spherical cavity formed therein;
the lower cavity having an undercut depth of 0.002 inch or less in the mating surface,
wherein when the mold cups are assembled a flash material flows controllably along the parting line during a high pressure close.

13. The mold according to claim 12, wherein the undercut comprises 360 degrees or less of the mating surface.

14. The mold according to claim 12, wherein the layer is an inner cover layer.

15. The mold according to claim 12, wherein the layer is a cover layer

16. The mold according to claim 12, wherein the undercut is 0.001 inch or less.

17. The mold according to claim 12, wherein the mating surfaces of the molds creates a single straight line around an equator of the ball.

18. The mold according to claim 12, wherein the mating surfaces of the molds creates a parting line that is a single corrugated line around the ball.

19. The mold according to claim 12, wherein the mating surfaces of the molds is a result of a superposition of a base waveform with a secondary waveform, whereby wavelength of the secondary waveforms are substantially shorter than that of the base waveform

20. The mold according to claim 19, wherein the secondary waveform is continuous around equator of he molded golf ball.

21. The mold according to claim 19, wherein the secondary waveform is broken into individual segments that are applied in a periodic fashion to the base waveform
